(19) United States
(12) Patent Application Publication
(10) Pub. No.: US 2019/0015785 A1
(43) Pub. Date: Jan. 17, 2019

(54) CAPACITATIVE ELECTROKINETIC DEWATERING OF SUSPENSIONS

(71) Applicant: Azaroghly YAZDANBOD, Calgary (CA)

(72) Inventor: Azaroghly YAZDANBOD, Calgary (CA)

(21) Appl. No.: 16/132,620

(22) Filed: Sep. 17, 2018

Related U.S. Application Data
(63) Continuation-in-part of application No. 14/079,148, filed on Nov. 13, 2013.
(60) Provisional application No. 61/725,742, filed on Nov. 13, 2012.

(51) Int. Cl. B01D 61/56; B01D 61/42; B01D 57/02; C02F 11/12; C02F 11/00; H01G 11/24; H01G 11/78

(52) U.S. Cl. CPC B01D 61/56; B01D 61/427; B01D 57/02; C02F 2103/10; C02F 11/006; H01G 11/24; H01G 11/78; C02F 11/12

(57) ABSTRACT

Capacitive electrokinetic densification, decontamination and dewatering of suspensions and soils can be performed while controlling and/or preventing chemical and pH changes in the densified material and extracted water. High electrical capacitance electrodes or Electric Double Layer Capacitor (EDLC) electrodes are used which can operate without redox reactions occurring on their surfaces until their developed voltage reaches the standard electrode potential of the electrode. Water-retaining, flexible covers for the EDLC electrodes have drainage and filtering capabilities and are made of a fabric which allows the passage of ions, water and electricity therethrough and facilitate continuous electrical contact between the EDLC electrode and the surrounding suspension.

### CROSS REFERENCE TO RELATED APPLICATION

This application is a continuation-in-part application of U.S. patent application Ser. No. 14/079,148 filed Nov. 13, 2013, which claims the benefit of U.S. Provisional App. No. 61/725,742 filed Nov. 13, 2012, the disclosures of which are incorporated herein by reference in their entirety.

### FIELD OF THE INVENTION

The present invention generally relates to processes for dewatering and densification of colloidal suspensions, and more specifically to a capacitive electrokinetic process and apparatus for extracting water and densifying solid particles present in colloidal suspensions, such as oil sands tailings.

### BACKGROUND OF THE INVENTION

Currently more than 170 square kilometers of the province of Alberta, Canada is covered by ponds which are being used as settling basins for over one billion cubic meters of freshly-generated soil suspensions, commonly referred to as oil sands tailings. A mixture of water, sand, silt, clay, contaminants, unrecovered bitumen and hydrocarbons, oil sands tailings are a waste by-product from the oil sands extraction processes. The oil sands of Canada are the third-largest proven oil reserve in the world and represent 97% of Canada's proven oil reserves. Oil extraction from the oil sands can produce more than 2 million barrels of oil per day, with almost half of it produced by surface mining. The surface mined material is processed to extract the oil, using rather large volumes of water. The remainder of the material after extraction of the oil forms oil sands tailings. The daily volume of tailings generated is estimated to be over 200,000 cubic meters. Recovery of water from and densification of these very large volumes of colloidal and charged particle suspensions and soils can be extremely difficult to accomplish.

Conventional tailings facilities involve delivery, often via a pipeline, of a slurry of tailings (typically about 10-20% solids by weight) from the oil sands processing facility. The tailings are deposited into the ponds hydraulically, in a loose state, and are contained by containment dams. Once in the pond, larger solids within the tailings quickly sink to the bottom while the finer solids remain suspended, so that the suspension has a higher water content near the top as compared to the bottom. As more solids begin to settle over time, the water from the top few meters can be recovered and re-used in the oil extraction process.

A number of challenges exist with tailings ponds, however, including seepage of contaminants and toxins into the ground water. The middle layer, mostly a mixture of clay and water called fine tailings, takes a long time to settle and solidify. Even after many years, the fine tailings now called Mature Fine Tailings (MFT) that at this time have about 20% to 40% solids by weight have the consistency of soft yogurt and are not sufficiently densified so that they could be capped. The remaining water, usually formed and remaining on top of the densifying suspension, typically contains concentrations of many chemicals and hydrocarbons that are toxic to fish and pose a risk to waterfowl. Nevertheless, this water still has the appropriate composition for reuse in the oil extraction process, and its reuse reduces the need for fresh water intake.

Freshly generated tailings contain a large volume of water in addition to their other constituents, and larger ponds are being employed for their storage. It is critical for the industry to both recover the water from these slurries/suspensions and to control their chemical composition, as changes in chemical composition of the water, especially its pH, can affect the optimum operation of the oil recovery processes from the oil sands. A pH of about 8.5 to 9.0 is deemed optimal for the oil extraction processes presently being used.

Despite many years of research and millions of dollars of expenditures, no clear-cut economic solution for treatment, densification and eventually capping of open tailings ponds has been found. The industry continues to develop better technologies and approaches to tailings management in order to reduce their environmental impact. Several technologies have been implemented and more are being tested to reduce the volume of fine tailings and speed up their rate of solidification, while also recovering the entrained water for reuse. While in situ electrokinetic dewatering facilities, plant based high-density thickening facilities, filtering facilities, centrifuge facilities, and facilities using coagulants in the form of polymers have all attempted to convert tailings ponds to reclaimable landscapes, an improved means to decrease costs, improve scalability, accelerate reclamation time, and reduce the environmental impact of tailings ponds would be beneficial. Indeed, government of Alberta now requires all oil sands operators to have plans in place to convert fine tailings to reclaimable landscapes upon mine closures.

In addition to colloidal suspensions in the form of oil sands tailings, there is a need in the art for more efficient and economic means for densification and dewatering of other types of colloidal suspensions containing electrically charged particles (typically negatively charged). Such suspensions include clay slurries, coal ash slurries, clay rich mine tailings, industrial waste suspensions, paper mill slurries, biological wastes, biomass sludges, as well as nutritional/food-related suspensions. In all of these cases a need exists for faster dewatering processes in which the chemical composition of the densified material will not damage the environment, and the extracted water can be reused. This requires minimal changes in chemistry and pH of the densified material and the extracted water. With food-related applications it can be important to maintain the initial chemical composition of the suspension's extracted fluids and densified solids, since the products are intended for human or animal consumption. For example, large suspensions of soy milk are commonly dewatered and densified for the production of tofu. Other nutritional applications include the production of tomato paste, apple pomace, or vegetable wastes as animal feeds, and with each of them the recovery of suspension fluids and solids without chemical changes is vital.

Ions in a colloidal suspension are attracted to oppositely charged particles and surfaces. For example, positive ions (cations) in a clay suspension are attracted to the predominantly negatively charged surfaces of clay particles due to electrochemical and Coulomb interactions, forming a layer of positive charge around the clay particles. This first surrounding layer is commonly referred as the Stern Layer, and it is typically dominated by cations which strongly adhere to the negatively charged clay particle surfaces. A second layer of hydrated ions are attracted to the first layer, also via Coulomb forces. This second layer, often called the “diffuse layer”, is also loosely associated with other surrounding suspended particles and ions. The diffuse layer electrically screens the first layer with hydrated ions, and, while lining up in a generally parallel formation with the first layer, it can move in the suspension/solution under the influence of electrical attraction and thermal motion, rather than being firmly anchored. These two layers of charged ions surrounding a solid particle are typically referred to as an Electric Double Layer (EDL) formation, a Debye Double Layer, a Diffuse Double Layer, or simply a double layer, which as used herein all refer to the same thing.

As is well-known, to establish an electric field within an electrically conductive colloid suspension or electrolyte solution, and to cause sustained movement of charges within that suspension/solution, at least two oppositely charged spaced apart electrodes and a direct current power source are needed. More specifically, electric current can be caused to flow through a colloidal suspension such as a clay suspension when an electric potential difference is applied between two (typically) metal electrodes immersed apart in a suspension. Once the two electrodes are placed in the clay suspension and then energized by the electric power source, a closed circuit is achieved, allowing for the flow of electricity through the suspension.

As electricity flows through the suspension, negatively charged clay particles are caused to travel towards the anode (positive electrode) and densify/deposit when they meet a barrier such as the anode electrode. This travelling of charged solid particles through a liquid or suspension due to the application of an electric field is known as electrophoresis. The water portion of the colloidal suspension can also be caused to travel or flow through the suspension under the influence of the electric field. This phenomenon is known as electro-osmosis. Positively charged ion movement towards the cathode (negative electrode) essentially drags water molecules along for the ride through the fine pore structure of saturated soils or suspensions.

The electro-osmosis and electrophoresis processes described above are both the result of Coulomb forces induced by an electric field on mobile electrical charges (i.e. charged particles and ions) in suspensions, and both processes have been applied to the separation of clays and many other materials from aqueous colloidal suspensions. When applied to aqueous clay suspensions, electrophoresis leads to the deposition of the negatively charged clay particles at or near the anode (positive electrode), whereas electro-osmosis functions as an aid in consolidating and concentrating suspensions by removal of the entrained water at or near the cathode (negative electrode). In addition, as some of the negatively charged clay particles approach each other, their positively charged ends are attracted to the much larger negatively charged surfaces of other clay particles, forming the well-known flocculated soil structure of clays, and resulting in their observed cohesive (adhesive) behavior. Electro-osmotic flow of water out of these electrophoretically densified material leads to their further densification. Such electrokinetic processes are well known in the civil and geotechnical engineering arts, where they have been practiced for decades using standard metallic electrodes to consolidate and strengthen soft clay formations.

Metallic or graphite electrodes are currently used in all current electro-osmotic dewatering applications, and maintaining the current flow requires the occurrence of redox (reduction-oxidation) reactions at both electrodes. U.S. Pat. No. 9,896,356 to Smith et al. is a good example of such use of metallic electrodes. Specifically, current will flow through a given suspension or electrolyte solution when the potential difference between the metallic electrodes and the surrounding solution is greater than the standard electrode potential of the electrodes, due to the occurrence of redox reactions at the metallic electrodes.

FIG. 1 is a schematic representation of the electric potential pattern (voltage drop) within a prior art electrochemical cell, in which a positively charged metallic electrode, or anode 1 and a negatively charged metallic electrode, or cathode 2 are placed in a suspension/solution 3. Here it is assumed that the applied potential difference between these two metallic electrodes causes charge flow within the conductive suspension. The trends of voltage drops are shown as ΔV₄, ΔV₅, and ΔV₆, with numeral 4 representing the voltage drop at the interface between electrode 1 and the suspension 3, numeral 5 representing the resistive voltage drop across the suspension 3 based on Ohm's law, and numeral 6 denoting the voltage drop between the suspension 3 and the negatively charged electrode 2. Positively charged ions 7 are attracted to the negatively charged cathode 2 and negatively charged ions 8 are attracted to the positively charged anode 1. The sum of the voltage drops (ΔV₄ and ΔV₆) at the two electrodes 1, 2, based on their standard electrode potentials, is typically about 2 to 4 volts, while the voltage drop (ΔV₅) across the suspension/electrolyte solution 3 even in a small cell could be about 10 to 20 volts.

The standard electrode potential is the measure of the individual potential of an electrode at standard state causing a specific electrochemical reaction. Values for standard electrode potentials are most often defined by measuring their potential relative to a standard hydrogen electrode using 1 mole per liter solution at 25° C. at one atmosphere of pressure. Standard electrode potential tables list these minimum required potentials for ideal conditions. In real conditions, these minimum standard electrode potentials are used as an indicator of when these redox reactions will begin to occur on the electrodes. This is evidenced in FIG. 1 wherein the voltage drops at the two electrodes 1, 2 (i.e. ΔV₄ and ΔV₆) represent electrode potential differences between the electrodes and the suspension. It is also noted that the voltage drop (ΔV₅) across the suspension is responsible for driving the electrokinetic processes of electrophoresis and electro-osmosis within the suspension.

While use of metallic electrodes in electrophoretic and electro-osmotic dewatering systems is well-known and beneficial, the electrical current flow between the electrodes leads to the formation of redox reaction products. Depending on the ions present in the suspension/solution, various oxidation and reduction products can be generated at the electrodes which can change the chemistry of the suspension as well as the water being extracted. For example, in all cases where metallic electrodes are used the pH at the cathodes dramatically increases, affecting pH of the electro-osmotically generated water at or near the cathode (electrode 2 in FIG. 1) by splitting of water and generation of hydrogen gas. Accumulated gases on the surface of electrodes present another problem, causing an increase in electrical resistivity and wasting energy. Furthermore, passage of generated redox reaction products such as hydroxide ions, also produced by splitting of water at the cathode, through the suspension under the influence of the electric field can alter the chemical composition of its solid constituents. In the food industry, for example, changes in food suspensions pH, caused by redox reactions occurring at the electrodes, can be very detrimental.

As shown below, hydrogen ions can be produced at the cathodes by the splitting of water molecules to form hydrogen gas and hydroxide ions. This reaction can be written as:

2H₂O+2e⁻4H₂+2OH⁻ (Equation 1)

The Standard Electrode Potential for this reaction is −0.8277 volts, which is represented by ΔV₆ denoting the voltage drop between the suspension 3 and the negatively charged electrode 2 in FIG. 1. The generated hydroxide (OH⁻) ions increase the pH of the water near the cathodes, and also form caustic compounds by interacting with cations in the suspension. For example, the hydroxide (OH⁻) ions can interact with sodium (Na⁺) ions present in the suspension to form caustic sodium hydroxide (NaOH). Therefore, in prior art electrokinetic dewatering processes using metallic electrodes, the electro-osmotically generated water flow at the cathode typically has an elevated pH. The negatively charged hydroxide ions (OH⁻) may also flow towards the anode to alter the chemical composition of the suspension. At the anodes, oxidation reactions can form gasses such as chlorine gas, resulting from oxidation of the negatively charged chlorine ions drawn towards the anode. Occurrence of redox reactions at electrodes also lead to corrosion of electrodes as charge is exchanged between ions and the electrodes. In short, metallic electrodes used in prior art electrokinetic dewatering systems will encounter corrosion problems which affect the electrical resistance of the electrodes, and can cause pH and chemical changes in the extracted water and densified material. In any practical electrokinetic dewatering system these issues need to be considered and addressed, as they affect energy consumption as well as the chemical makeup of the extracted water and the densified solids.

A “capacitor” as defined herein is an electric energy storage device made of two electrically conductive plates, which functions on the basis of removal of electrons from one conductive plate and placement of electrons onto the other conductive plate by the action of an electric field. This charge separation leads to a potential difference between capacitor plates and storage of electric energy by the capacitor. The electric potential, the electric charge and the electric energy stored in capacitors can then be used when capacitors are used in electric circuits.

Capacitance (C) of a capacitor in units of Farad is defined as the ratio of the amount of charge (Q) in units of Coulomb placed on or removed from each of capacitor plates, to the potential difference (V) in units of Volts between capacitor plates, or:

C=Q/V (Equation 2)

This electrical capacitance is a function of capacitor geometry and plate material and the permittivity of the material between the two capacitor plates. Capacitance increases with larger plate sizes, smaller distance between plates, higher permittivity of the material between plates and the use of higher surface area plate materials. In addition to the effect on increasing the permittivity, the choice of the dielectric material placed between the capacitors plates also set the limit for the maximum potential difference between plates as it relates to sparking which is electric discharging between capacitor plates or the breakdown of the dielectric between the plates that typically destroys the capacitor, as the charges on the two plates are no longer separated and are exchanged. An alternative way of calculating the capacitance of a capacitor for parallel plate capacitors is:

C=K*ε₀*A/d (Equation 3)

Here “K” is the dielectric constant of the dielectric material between the capacitor plate, “ε₀” is the permittivity of free space equal to 8.85E-12 Farads/meter, “A” is the surface area and “d” is the distance between the capacitor plates. If we assume a charged electrode in the shape of a plate is placed in an electrolyte, then ions of opposite polarity with respect to the charge placed on the electrode are attracted to it. Because the ions in an electrolyte are hydrated and if the potential difference between the electrode and the ions attracted to it is less than the standard electrode potential of these ions, there would be no charge exchange between the electrode and the ions. This arrangement of ions on the electrode closely resembles a charged capacitor in which one plate is the electrode and the other plate is the ions, separated from the electrode by their hydration shell that also constitutes the dielectric between these capacitor plates. This arrangement could best be described as an electrochemical capacitor. In this case, Equation 3 could be a good representation of the capacitance between the ions (charges) and the electrode body wherein the distance “d” between the ions and the electrode surface (the two plates of the capacitor formed) are established by the thickness of the hydration shell of each ion and are very small and in the order of a few Angstroms. Thus, electrolytic capacitors have much higher capacitances in comparison to regular metallic capacitors with air or solid material between the electrodes as the dielectric wherein the distance between the plates are much larger.

As outlined above, prior art electrokinetic dewatering systems use metallic or graphite electrodes. Metallic electrodes are very low capacitance electrodes in which the potential difference between each electrode and the dissolved ions around it are equal or higher than the standard electrode potential. While such low capacitance electrodes may momentarily generate capacitive electric fields in clay suspensions, they do so only for a small fraction of a second before redox reactions occur on their surfaces. Specifically, only a small number of ions (in the order of a few milli-Coulombs or E-03 Coulombs) are capacitively absorbed to the relatively tiny surface area provided, such that their full capacitance is reached within a small fraction of one second. They have such a low available electric capacitance that there is zero electric field between them at potential differences lower than their standard electrode potentials. Therefore, establishment of a continuous electric field through the suspension when such low capacitance electrodes are used requires the application of a higher electric potential difference between the electrodes, which leads to the aforementioned occurrence of redox reactions at their facings. As noted, redox reactions generate gases and create pH changes and chemical reactions in the soil/suspension, leading to corrosion of the electrodes, loss of electrical contact between the electrodes and the suspension due to formation of gas bubbles on their surfaces, and increased electrical resistance.

To establish an electric field within a suspension and cause sustained movement of charges, at least two oppositely charged electrodes are needed. Once two electrodes are placed in a suspension that is electrically conductive and are energized by a direct current electric power supply, a closed circuit is achieved, allowing for flow of electricity. In this circuit, electrons move away from the anode electrode to the cathode electrode through the power supply and, within the suspension the positive charges begin to move towards the cathode and the negative charges begin to move towards the anode. If the electrodes used are normal electrodes such as metallic or graphite electrodes, maintaining the current flow requires the occurrence of redox (reduction-oxidation) reactions at both electrodes. This means that in such settings, sustaining an electric current flow requires that as the ions from the suspension or the electrolyte approach and then reach the electrodes, charge exchange or redox reactions occur on both electrodes as is well known by the practitioners of science of electrochemistry. Redox or electrode reactions occur when the potential difference between the electrodes and the ions absorbed to it are measurably higher than the standard electrode potentials for the given ionic species. The standard electrode potential is the measure of the individual potential of a reversible electrode reaction at standard state. This means that the current would flow in a given suspension or electrolyte if the applied potential difference between the electrodes are high enough to accommodate for occurrence of redox reactions at the electrodes.

The Standard Electrode Potential tables list these minimum required potentials for ideal conditions. In real conditions, these minimum potentials could be used as a good indicator of high probability of occurrence of redox reactions on real electrodes. But, if the applied potential difference between the two electrodes is low enough that the potential difference between each individual electrode and the ions next to it are lower than the standard electrode potential of the ion species absorbed to each electrode, the ions moving towards the electrodes will attach to these electrode surfaces, much like the ions drawn towards the charged clay particle surfaces and form an electric double layer on the electrode surfaces without occurrence of redox reactions. In this sense, the behavior of ions at the surface of the electrodes is similar to that of ions absorbed to the surfaces of clay particles and also similar to what happens in electrolytic capacitors, as long as the potential difference between the adsorbed ions and the surface of the electrode is less than the potential difference necessary to cause charge exchange (i.e. redox reactions, aka electrode reactions) between the ions and the electrodes. However, if the potential difference between the two normal electrodes is high enough that the potential difference between each individual electrode and the ions on it is higher than the standard electrode potential of the given ion species absorbed to them, then electrode or redox (reduction and oxidation) reactions are initiated, wherein electric charges (electrons) are exchanged between the electrodes and their adjacent ions as is well known by electrochemists.

Based on all the above, it could be concluded that the equivalent circuit for the DC power supply connected to two metal electrodes in a conductive suspension or electrolyte under the conditions in which the applied potentials between the electrodes are lower than the limit to cause electrode reactions is a power supply with two capacitors in series connected to it. Electricity flows in such a circuit until the capacitors are filled and then stops flowing.

As all prior art electrokinetic dewatering systems use normal and mostly metallic or graphite electrodes where in the potential difference between each electrode and the ions adjacent to it are higher than the standard electrode potential for the ion species, their function by necessity includes redox reactions at the electrodes to establish electric current flow. Occurrence of electrode reactions by necessity results in oxidation (loss of electrons) of negatively charged ions at the anode and reduction (gaining electrons) of positively charged ions at the cathode.

These normal electrodes also encounter corrosion problems, which can affect the electrical resistance of the electrodes as is commonly known by people with common knowledge of electrochemistry. In any practical electrokinetic dewatering system these issues need to be considered and addressed as they affect energy consumption and the chemistry of the extracted water and the densified solids. The solutions presented to date to overcome these changes in the chemical composition of the densified material and the extracted water include introduction of stabilizing chemicals such as injection of carbon dioxide or mixing such chemicals as lime or ammonium carbonate or ammonium bicarbonate with the suspension as proposed in U.S. Pat. No. 4,501,648 to Ritter or allowing the electro-osmotic flow of low pH (acid) solutions potentially forming at anodes to reach the cathode, as proposed by U.S. Pat. No. 9,896,356 to Smith, et al. As electro-osmotic flow is away from the anode, in practical terms, this requires input of additional water to the vicinity of the anode that reduces the net amount of the extracted water. This is because the net amount of water electro-osmotically removed from a given volume of soil or suspension is equal to the difference between the amount of water removed at cathode and the amount of water entering the soil/suspension at the anode. So, by adding water to the anode location, the net amount of water that could electro-osmotically be removed is reduced.

The rates of electrophoretic and electro-osmotic flows are each directly proportional to the intensity of the established electric field. Thus, with higher electric field intensity (electric potential difference per unit distance with units of volts per meter) there will be higher electrokinetic flow rates of particles and water. Thus, for a given geometric arrangement of electrodes in a uniform material/suspension, the higher the potential difference between the electrodes, the higher the electrokinetic flow rates will be.

As in typical clay suspension the electro-osmotic flow is towards the cathode, the net amount of water electro-osmotically removed from a given volume of soil or suspension is equal to the difference between the amount of water removed at cathode and the amount of water entering the soil/suspension at the anode. This reduces the effectiveness of in situ electro-osmotic process in removing water from tailing ponds wherein the water table is almost always above the suspension, resulting in its easy flow to anode location. This along with large electrode spacing requiring high voltages and the electric resistivity buildup by densification of suspended solids on the anodes, constitute some of the major drawbacks of in situ application of electrokinetic processes to oil sands tailings ponds. In such in situ applications, the densification of solids near the anodes can be such that the buildup of resistivity dissipates most of the electric energy there, reducing the electric field intensity away from the anode electrodes, rendering the continuation of the process ineffective. This is based on the fact that when two higher and a lower resistance elements are placed in series in a DC electric circuit with a constant voltage applied across the two resistive elements, then based on Ohm's law, the potential drop across the higher resistance element is more than across the lower resistance one.

The fact that electro-osmotic flow is away from the anode also means that during applications of electro-osmosis for in situ dewatering operations, if no additional water is supplied to the vicinity of the anode, consolidation and densification of the suspension/soil near the anode becomes more pronounced than near the cathodes. Further, with removal of water from the vicinity of the anodes and, due to the resulting consolidation/densification and volume reduction in the densified suspension around the anodes, the contact between the suspension and the electrode is reduced, which increases the electric resistance between the anode electrode and the suspension, in turn leading to reduced electric current flow at constant voltage or the need to increase the applied potential to maintain a constant current. This further reduces the electric field intensity within the rest of the suspension, reduces the production rates and wastes energy. To counteract this and in cases where chemical and pH changes in the extracted water and/or the densified suspension are not important, as in some soil decontamination projects, water can be allowed or facilitated to enter to the vicinity of the anodes to improve electric conductance. Indeed, U.S. Pat. No. 5,074,986 to Probstein et al., discloses that a purging liquid can be introduced at the anode (referred to as the “source” electrode) to facilitate the removal of contaminants by electro-osmotically generated water flow through the suspension. Nevertheless, when liquids are added at the source electrode, the net amount of water removed from the suspension is reduced, thereby reducing the water removal efficiency of the system.

In classical applications of electro-osmosis for dewatering and/or decontamination of soils, which are routinely practiced in situ on natural or manmade soil layers, anodes are typically chosen to be solid metals and are placed in contact with or otherwise immersed in the surrounding soil, while cathodes are typically perforated or are made of wires and are placed in open holes made in the suspension, to allow for collection and discharge of water entering them. This is typically referred to as a “closed anode and open cathode” condition. U.S. Pat. No. 5,584,980 to Griffith et al. postulates arranging a plurality of adjacent electrode “panels” in rows placed directly into the soil. The electrode panels include “flowable treatment media” generally made of sand and gravel particles surrounded by a geotextile filter layer. These electrode panels are used for adding or removing liquids to and from the vicinity of the electrodes and maintaining electrical contact between the electrodes and the suspension/soil. Removal of excess water from the treatment panels is accomplished by installing a vertical perforated pipe on one side of the panel and pumping the excess water out. These panels function so long as the voids between sand and gravel constituting them remain filled or nearly filled with water. However, if these voids are effectively drained, the continuity in electrical path for flow of electricity (ions) will be broken and the flow of electricity reduces or stops.

Since 1957 a new concept in capacitors has emerged. This new concept is what is typically referred to as super-capacitors or electrochemical capacitors or electric double-layer capacitors (EDLC) which all refer to the same thing and refer to capacitors made up of electrodes having an extremely high surface and having an extremely high electrical capacitance, and as a pair they can receive a colloidal suspension or electrolyte solution in between them. This means that in EDLCs the insulating dielectric is replaced with an electrolyte and the plates are usually made up of high surface area material incorporating such material as activated carbon, carbon aerogels or carbon aerogel composites. Carbon aerogels are electrically conductive and porous material having a very large surface area. This means that when charged each EDLC electrode could also function as one plate of a capacitor wherein the other plate is a collection of ions capacitively attracted to it and separated by the hydration shell of the ions. With a view to Equation 3 above, it could be appreciated that due to much larger surface area and extremely small separation between these charged capacitor plates, a very high electrical capacitance is available in EDLCs. The capacitance of each EDLC plate is several orders of magnitudes larger than regular capacitors that use metallic plates and insulating dielectrics.

Thus, a charged EDLC which uses two high surface area plates, includes two internal capacitors placed in series. In each of these internal capacitors, one capacitor plate is made up of a charged, conductive, high surface area plate and the other is made up of concentration of ions of opposite polarity in comparison to the charge on the high surface area plate with a very small separation between the two. The capacitance of a two plate EDLC is governed by the equivalent capacitance (Ceq) of the two internal capacitors (with capacitances of C1 and C2) that are connected to each other through the conductive electrolyte through the following equation:

1/Ceq=1/C1+1/C2. (Equation 4)

The present invention builds upon the disclosure of its parent application, i.e. U.S. patent application Ser. No. 14/079,148 (“the '148 application), filed Nov. 13, 2013 by present inventor A. Yazdanbod. The '148 application teaches single or multicompartmental dewatering devices within an insulated container that uses two Electric Double Layer Capacitor (EDLC) electrodes spaced apart within the container to generate the needed electric fields. With reference to FIG. 2, taken from the '148 application one embodiment of an apparatus 1 of the present invention involves the use of high electric capacitance electrodes 10, 11, typically in the form of electric double-layer capacitor (EDLC) electrodes, as a means of generating the electric fields required for concentrating, decontaminating and dewatering particulate/liquid suspensions or saturated soils 13. EDLC electrodes are employed in the saturated suspensions to cause electrokinetic flow in the form of electrophoretic and/or electro-osmotic flow. In order to avoid/prevent electrolysis reactions at the electrodes, the polarity of the applied potentials to the capacitor electrodes 10, 11 can be reversed before the potential difference between one or both of these electrodes and their adjacent suspension reaches the level that could cause electrode reactions. In contrast, polarity reversals in other related prior art devices are not related to the use of EDLC electrodes and the avoidance of corrosion and pH and chemical changes in the densified material and the extracted water, but are directed to dislodging the electrophoretically deposited material from electrode surfaces or for cleaning out filters that might have been clogged (e.g., see U.S. Pat. No. 6,871,744 to Miller et al, or US Pub. No. 2012/0292186 to Adamson).

As illustrated in FIG. 2, the invention can use specific, rather thin, ion conducting linings or covers 14, 15 having high hydraulic drainage properties to surround and/or cover the high electric capacitance electrodes 10, 11. These covers 14, 15 allow for reliable electric contact between the electrodes and the suspension 13. Combined with the capability of such fabrics to gravitationally drain water, the covers 14, 15 allow for separate electric (ionic) and fluid flow with minimal electrical resistance. Drain line outlets 16, 17 facilitate the removal of fluids from the electrode covers 14, 15, and can either be non-flexible plastic tubing or flexible tubing capable of fluid conductance.

Thus, looking at the apparatus 1 of FIG. 2, an insulated plastic container 12 includes high electric capacitance electrodes 10, 11 having the capability of electrical double layer capacitors (EDLCs), wherein the capacitor electrodes 10, 11 are connected to the opposite poles of a direct current electric power supply (not shown) to establish an electric field between them. If, as a non-limiting example, suspension 13 is a suspension of normal clays in which the individual clay particles have negatively charged surfaces, the electric field will cause the movement of these negatively charged clay particles in this suspension 13 in the opposite direction of the electric field (from cathode to anode) and their accumulation on filter/drainage linings 14 or 15 on the side facing the particle flow direction. Continued electrophoretic flow of the suspension load (such as clays) will lead to their relative densification and precipitation on the linings 14, 15. Also, the generated electric field will cause the flow of ions through the covers 14, 15.

There is a transition between electrophoretic and electro-osmotic flow within a given body of electro-active material, such as in aqueous suspensions of clays. With the application of an electric field, coulomb forces are exerted on the negatively charged clay particles and the double layer surrounding each clay particle. The strength of an electrical charge on a clay particle, or its degree of electronegativity, is often quantified in terms of its Zeta Potential. The Zeta Potential is usually defined as the electrical potential at the junction between the fixed and mobile parts of the electrical double layer. It is dependent on the pH of the surrounding liquid and is also influenced by the valence of the ions present. As the association between clay surfaces and high valence cations increases, the zeta potential decreases. If the particle is suspended in a solution, the coulomb forces acting on such negatively charged particles cause them to move in the opposite direction of the applied electric field (i.e. electrophoresis occurs). The two key phenomena for electrokinetic dewatering are electrophoresis and electro-osmosis. As the particles move and are brought close enough to each other to prevent their further movement, then the coulomb forces acting on the double layer will result in the movement of the double layers and the pore fluids adjacent to them, causing electro-osmotic flow.

The '148 application discussed above also includes a multi-compartmental embodiment that includes a number of interceptor drains positioned between the electrodes as presented on FIG. 3 and FIG. 4. In this embodiment interceptor drains in the form of electrode cover fabric sheets (identified by numeral 22 between the two electrodes) are used to shorten the path the electro-osmotically generated water flow has to travel before it is removed from the cell through the interceptor drains and also shortens the path for electrophoretic movement of particles as they are deposited on the interceptor drains. This embodiment provides a means to detect the initiation of redox reactions at the EDLC electrode surfaces by monitoring for and detecting voltage changes between the EDLC electrode surfaces and the suspension. Specifically, upon continued application of an electric current between EDLC electrodes 20 and 21, gradually and over the course of several minutes to as long as half and hour to one hour (as a function of the available capacitance of the EDLC electrodes and the magnitude of the current) the potential of ions absorbed at each high capacitance electrode reach a level that will cause Faradic/redox reactions (i.e. electrolysis reactions) that lead to generation of gases and pH and chemical composition changes in the densified material and the extracted water.

These EDLC electrodes each have an extremely large capacitance, function without electrode (i.e. redox) reactions, and are capable of avoiding redox reactions by reversing the polarity of the electric current provided by the power source when the EDLC electrodes' capacitances approach their related standard electrode potentials. Each electrode also incorporates an electrode cover, which is a water retaining (wettable), flexible fabric with drainage and filtering capability and the capability to pass electric currents when wet. The electrode covers facilitate fluid removal from the location of the cathodes, and they also help maintain electrical contact with the suspension at both the cathodes and the anodes. Such electrode covers provide improved filtering, drainage and electrical conductance functions.

When the devices disclosed in the '148 application is filled with a suspension such as a clay slurry, and when an electric field is established between the EDLC electrodes by connecting each EDLC electrode to one pole of a DC power supply and thus establishing an electric field within the suspension, water moves in each compartment in the direction of the electric field towards the cathode, while clay particles move in the opposite direction towards the anode. The resulting densified material, which are deposited on and near the anode cover and each interceptor drain on the side facing the cathode, can then be directed downward by “moving blades” and by gravity, and afterwards removed from the system by such means as helical screws at the bottom of each compartment. In addition, each electrode cover and interceptor drain are connected to a drain pipe, which helps remove the electro-osmotically driven water from the device. With polarity reversal necessitated by the use of EDLC electrodes, at any given time, one electrode would function as the cathode and the other one as the anode, and then they switch roles. This means that as the process advances, densified material form on both sides of the interceptor drains as well as on both electrode covers need to be removed therefrom.

In practice, a number of issues lower the production rate in the above referenced multi-compartmental device. First, densification of the material on the electrode covers and on the interceptor drains distorts the electric field distribution within the cell, such that major voltage drops occur at these locations that require systematic scraping. In other words, the passage of the electrical current through the suspension is governed by Ohm's law: I=V/R wherein I is the electric current in amps, V is the potential difference applied between the electrodes in volts and R is the electrical resistance of the suspension and the interceptor drains between the electrode. As the resistances in such device are made up of the resistances of the individual parts (interceptor drains and each body of the suspension in each compartment) and they constitute resistors in series and, given the fact that the same current passes through all parts within the device, then the voltage drop in each resistor (interceptor drain and/or each compartment) is proportional to the electric resistance therein. As the densified layers have higher resistivity and therefore higher resistance, then the voltage drops in these layers more than the equivalent thickness of the remainder of the suspension that is not densified. This necessitates the use of extensive instrumentation to detect voltage drop along the length of the dewatering cell to identify the location and the extent of resistance buildup because of formation of densified material layers and to guide the sequence of scraping operation to optimize production rate and to maintain product (densified and dewatered material) quality and uniformity. In addition, experience shows that both electrokinetic processes occur at higher rates in compartments closer to the electrodes, rendering the middle compartments less effective. Further, multi-compartmental cells equipped with just two electrodes require rather higher operational voltages that raise safety concerns for the operators and potential for stray currents and electrical shorts.

In the light of the above, and for electrokinetic dewatering processes and apparatus, especially when dewatering oil sands tailing, it would be beneficial to have a system in which the issue of water table being above the mud line could be eliminated, preventing the entrance of water to the location of the anode that would reduce the water extraction yield. It would also be beneficial to reduce the spacing between the electrodes to reduce the voltage level required to achieve a sufficient level of electric field intensity that would speed up both electrokinetic processes of electro-osmosis and electrophoresis. It would also be beneficial if the exposed area of each electrode in comparison to the volume of the suspension being treated could be increased in comparison to in situ operations. In addition, and with specific attention to dewatering needs of oil sands for control of chemical composition and pH of water for reuse in the oil extraction plant, it would be beneficial to have electrokinetic processes that avoid or control the amount of redox reactions occurring at the electrodes. Facilitating reliable electric contact between electrodes used and suspensions, while also allowing for simultaneous drainage of the electro-osmotically generated water from the location of the electrodes will also be beneficial. It would also be beneficial to provide a means for transforming the usually in situ dewatering and decontamination operations of suspensions to a plant-based operation, thereby allowing the design parameters to be optimized and providing a high volume, low cost means for treatment of particulate/liquid suspensions in general, and oil sands tailings in particular wherein the composition and pH of the densified material and the extracted water could be controlled or even kept constant and unchanged.

### SUMMARY OF THE INVENTION

Accordingly, the present invention provides an improved electrokinetic process and apparatus for dewatering and densification of large masses of colloidal suspensions and soils. The invention incorporates the use of specific high capacitance electrodes, as well as specific fabrics as electrode covers to aid in the dewatering process. The invention can provide electro-osmotic water extraction and electrophoretic densification of suspensions while the chemical composition and pH of the extracted water and densified materials are unchanged or allowed to the extend desired. The inventive process and apparatus can transform in situ dewatering and decontamination operations of suspensions and saturated soils to a plant-based operation, wherein the design parameters and requirements can be optimized.

One aspect of the invention provides a capacitive electrokinetic process for densifying solids and recovering water from colloidal suspensions without changes in chemical composition and pH of the densified material and the extracted water, the process comprising the steps of: (a) providing an insulated container, the insulated container including at least one outlet drain line for removing water therefrom; (b) providing an electric current power supply for generating an electric field through the suspension, wherein the power supply includes a positive pole and a negative pole and is capable of polarity reversal; (c) providing at least one pair of high capacitance electric double-layer capacitor (EDLC) electrodes connected to opposite poles of the power supply, wherein each electrode of the at least one pair of EDLC electrodes has a specific capacitance of at least 1.0 farad per gram and is spaced apart from the other electrode within the insulated container; (d) providing each EDLC electrode with an electrode cover for placement over the EDLC electrode, wherein each electrode cover is made of a fabric which allows the passage of ions, water and electricity therethrough and facilitates electrical contact between the EDLC electrode and the surrounding suspension; (e) providing each electrode cover with a drain conduit, wherein each drain conduit is positioned below its corresponding EDLC electrode and is hydraulically connected to its corresponding electrode cover and to the at least one outlet drain line; (f) providing a suspension to be treated in the insulated container; (g) applying a potential difference between the EDLC electrodes via the power supply to generate an electric field through the suspension, wherein electric current flow through the suspension is established and maintained by the EDLC electrodes without the occurrence of redox reactions at their surfaces so long as the potential difference between the EDLC electrodes and the ions in the surrounding suspension are below the standard electrode potential of the ions in the surrounding suspension; (h) detecting the initiation of redox reactions at the EDLC electrode surfaces; (i) upon the detection of redox reactions at the EDLC electrode surfaces, reversing the electric field direction through the suspension by reversing the polarity of the potential difference applied between the EDLC electrodes via the power supply; (j) removing water from the insulated container through the at least one outlet drain to achieve water extraction from the suspension and densification of solids within the suspension; (k) removing the treated suspension from the insulated container; and (l) repeating steps (g) through (k).

Another aspect of the invention provides a apparatus for capacitive electrophoretic densification of solids and capacitive electro-osmotic removal of fluids from a colloidal suspension, the apparatus comprising: (a) an insulated container for receiving and containing a suspension to be treated, the insulated container including at least one outlet drain line for removing water therefrom; (b) an electric current power supply for generating an electric field through the suspension, wherein the power supply includes a positive pole and a negative pole and is capable of polarity reversal; (c) at least one pair of high capacitance electric double-layer capacitor (EDLC) electrodes connected to opposite poles of the power supply, wherein each electrode of the at least one pair of EDLC electrodes has a specific capacitance of at least 1.0 farad per gram and is spaced apart from the other electrode within the insulated container; (d) at least one pair of electrode covers placed over the at least one pair of EDLC electrodes, wherein each electrode cover is made of a fabric which allows the passage of ions, water and electricity therethrough and facilitates electrical contact between the EDLC electrode and the surrounding suspension; and (e) at least one pair of drain conduits positioned below the at least one pair of EDLC electrodes, wherein each drain conduit is hydraulically connected one of the at least one pair of electrode covers and to the at least one outlet drain line.

The nature and advantages of the present invention will be more fully appreciated from the following drawings, detailed description and claims.

### BRIEF DESCRIPTION OF THE DRAWINGS

FIG. 1 is a schematic representation of the electric potential pattern (voltage drop) within a prior art electrochemical cell;

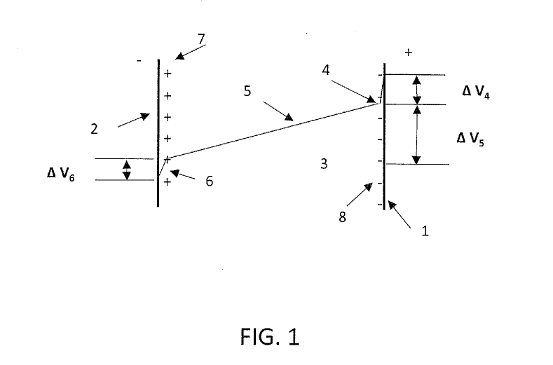

FIG. 2 is a schematic representation of one embodiment of an apparatus of the present invention;

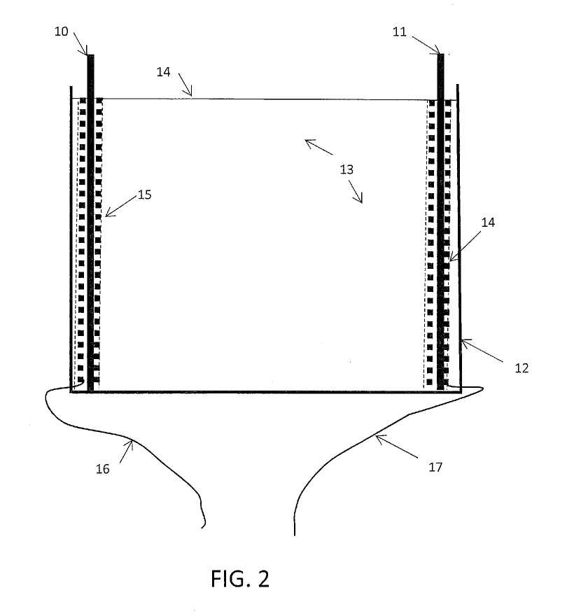

FIG. 3 is a schematic representation of a multicompartmental embodiment that includes a number of interceptor drain positioned between the electrodes;

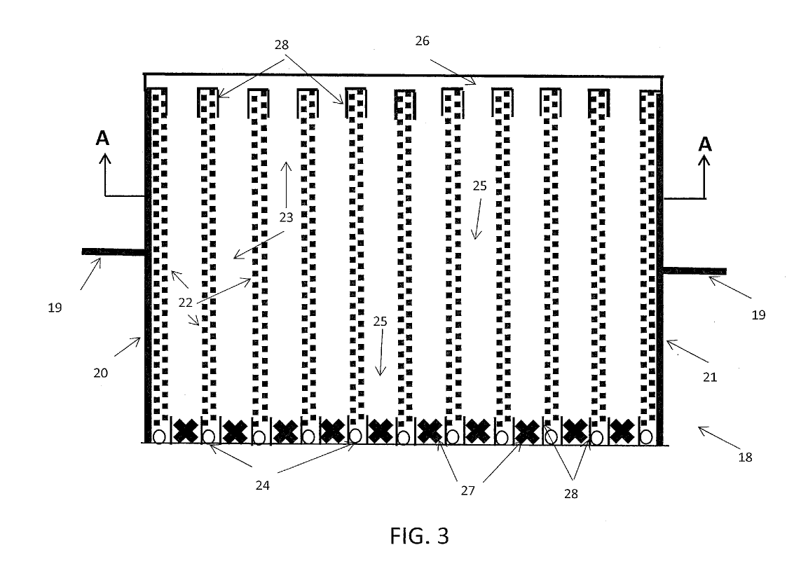

FIG. 4 is a cross section view of the multicompartmental embodiment presented in FIG. 3;

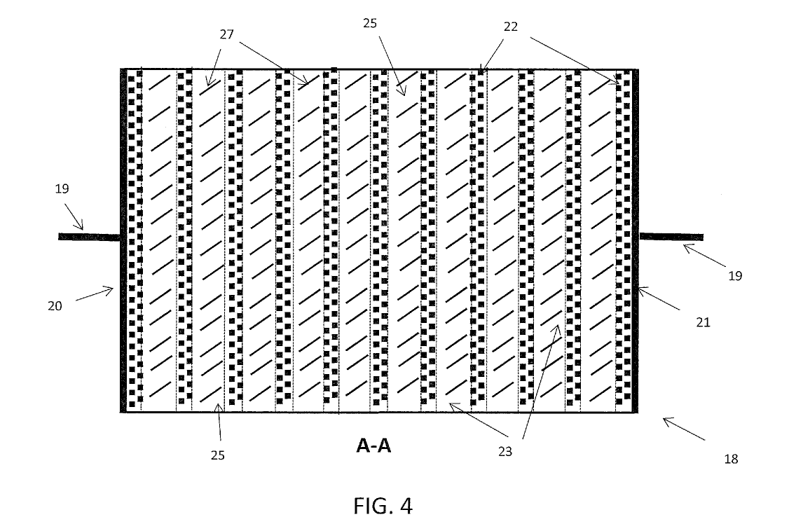

FIG. 5 is an illustration of a preferred embodiment of an electrode assembly for a capacitive electrokinetic dewatering apparatus, according to the present invention

FIG. 6 illustrates a capacitive electrokinetic dewatering apparatus according to the invention

FIG. 7 presents a graphical output of voltage developed vs. time for first cycle of a constant current dewatering test.

### DETAILED DESCRIPTION OF THE INVENTION

All terms used herein, relating to physical properties not specifically defined herein, are assumed to be used in their engineering sense and usability for the intended purpose. For example, when a pipe is referred to as a pipe drain, it is assumed that it has the required engineering specifications with respect to perforations and structural integrity and internal and external diameter to function as a pipe drain without excessive hydraulic resistance as a properly designed pipe drain would.

As defined herein, the terms “active electrode” and “counter electrode” can also mean “anode” and “cathode”, depending on their charge.

The terms “ion” or “ions” refer to an atom or molecule with a net electric charge due to the loss or gain of one or more electron. In electrolytes or in entrained water within a suspension, ions are hydrated ions which means that they are covered by a shell of water molecules. The amount of charge of an ion depends on the number of electrons lost or gained. For any ion missing or gaining one electron, the net charge is equals to that of an electron equal to 1.60217662×10⁻¹⁹ Coulombs.

The term “insulated container” refers to a container made of non-conductive material such as plastics or my metal covered by insulating paint, or a container internally lined with such non-conductive materials such as plastics.

The terms “suspension” or “slurry” refer in general to suspensions of electro-active materials in a fluid such as aqueous suspensions of fine mineral solids, particulate/liquid dispersions or suspensions, or low-density mixtures of suspended loads of surface-charged particles in a fluid, and in particular to clay-water suspensions such as Mature Fine Tailings (MFT), dispersions or suspensions of inorganic particles that are a by-product of mining, manufacturing or other industrial processes, food and food processing waste suspensions, biological wastes, and biomass sludges or oil sands tailings sludge, irrespective of the existence of other organic or inorganic constituents in the mix.

Electrode covers as referred to herein are preferably made of fabrics having the combined capabilities of being a water retaining (wettable) or hydrophilic, flexible single or multilayered fabrics with drainage and filtering capability and the capability to pass electric currents (ions) when wet and gravitationally drained. The draining capability of these fabrics also allow for passage of electro-osmotically generated water flow to pipe drains attached to them when used as electrode covers while also allowing for deposition of densified material thereon.

The capability of a fabric to function as an electrode cover is a result of the fabric having sufficient hydraulic conductivity to pass water across the thickness or through it and along its length or width without appreciable excess pressure buildup within its pores/passages. The capability of the fabric to function as a filter is the result of the fabric having appropriate pore sizes to prevent or effectively reduce the passage of suspension particles, so that the particles do not effectively plug the pores. The capability of the fabric to pass ions and water through its pores/internal passages when wet but gravitationally drained is the result of the fabric having the ability to form continuous ion flow paths through the fabric when wet while possessing such fine texture as to mobilize capillary forces to retain water on its inner porosity even when gravitationally drained.

Procedures for evaluating the drainage, the filtering and ion conduction capabilities (electric conductivity) of such fabrics are well known by those of skill in the art of geotechnical engineering and electrochemical engineering. Non-limiting examples of water retaining fabrics that can function as electrode covers and which also have the capability to pass ions under the influence of electric fields when wet, even when gravitationally drained, include the commercially available ShamWow!® cloth that has been found to be quite suitable for such uses. Other non-limiting examples of suitable electrode cover and drain fabrics can include non-woven fabrics such as “stiffened felt” or “premium felt” (sold under the trademark Creatology®) or various grades of non-woven clothing insulation liner (sold under the trademark Pellon®). Other fabrics may also be useful so long as their water retention, filtering, drainage and ion conductance properties match or qualify them for the intended use with respect to the suspension being treated.

When the ions in a conductive solution or suspension come in contact with a charged electrode, two differing outcomes are possible. If the potential difference between the ions absorbed to the surface of a charged electrode and the electrode body is more than the minimum potential difference needed to initiate electrode redox reactions, then such reactions take place and electrons are exchanged between the ions and the electrode. This is the concept of Standard Electrode Potential well known by people even with basic knowledge of electrochemistry as also referenced for the splitting of water molecules under Equation 1 above. However, if this potential difference is less than the minimum potential difference needed for initiation of redox reactions, that is, if this potential difference is less than the standard electrode potential of the ions absorbed to the electrode, then the ions remain capacitively absorbed to the electrode and nothing further happens. As a numerical example and assuming standard conditions (25 degree Celsius, 1.0 mole per liter concentration at 1.0 atmosphere pressure), if the potential difference between the negatively charged chlorine ions (Cl⁻) and a positively charged electrode is less than 1.36 volts (the standard electrode potential for oxidation reaction of chlorine ions), there will be no charge exchange between the electrode and these chlorine ions and these ions will just sit on the electrode without charge exchange. The Standard Electrode Potentials for electrochemical oxidation and reduction of ions are listed on Standard Electrode Potential tables in most references on electrochemistry, as know by persons with ordinary skills in the art of electrochemistry. These tables indicate that if the potential of an electrode is 1.36 volts higher than chlorine ions absorbed to it, the extra electron on the chlorine ion (Cl⁻) would leave the ion and enter the positively charged electrode, thus oxidizing the chlorine ion and transforming it into chlorine element (gas). With a view to Equation 2, this means that if the amount of charge Q capacitively absorbed to a given electrode with a capacitance C is less than the amount calculated at a voltage V of 1.36 volts, the voltage between the two charged plates of this internal capacitor (one plate being the absorbed hydrated ions separated by their hydration shell from the second plate that is the charged electrode body) is less than the minimum required for charge exchange, then nothing happens and the ions just sit on the electrode. However, if this internal capacitor is filled up to 1.36 volts potential difference between the capacitor plates, then the electrons would leave the chlorine ion and enter the electrode. This voltage of 1.36 volts is the minimum potential difference needed for this oxidation reaction. For appreciable rates of reaction at such electrodes, an over potential will have to be applied. The necessity for a minimum voltage development and filling of the capacitance of the electrode to such minimum voltages before electrode reactions occur means that if the capacitance of the electrode is high, large amounts of ions could be absorbed to it without any electrode reactions. As a numerical example, if an electrode has a mass of 60 grams and a specific capacitance (defined as capacitance per unit mass) of 5 Farads per gram, it would have a capacitance of 300 Farads. This means that as long as the total amount of chlorine ions capacitively absorbed to this electrode are less than 408 coulombs (see Equation 2, Q=C*V or Q=300 farads*1.36 volts=408 coulombs), there would be no electrode reactions at this electrode and no chlorine gas will be generated as the potential difference between these ions and the electrode will be less than 1.36 volts.

In this case if we assume the electric current “I” between two oppositely charged high capacitance EDLC electrodes, each with a capacitance of 300 farads placed in a common salt (NaCl) electrolyte is 2 amps and the resistance R of thus constructed circuit (power supply, electrode and the electrolyte) is 10 ohms, then based on the ohm's law, (V=R*I) the voltage supplied by the power source will be (10 ohms*2 amps) 20 volts. In this case the time t in seconds required to fill the capacitance of the positively charged electrode absorbing the chlorine ions will approximately be (t=Q/I) or 408 coulombs/2 amps equal to 204 seconds or 3.4 minutes. This also means that after about 3.4 minutes, electrode reactions could also begin on this high capacitance electrode. In comparison, if the same electrodes were metallic with typical capacitances in the range of a few milli-farads, then their capacitance would fill up to 1.36 in a few milli-seconds (almost instantaneously) and the electrode reactions would start almost immediately. These facts show that by the use of high capacitance EDLC electrodes, rather large electric currents can be sustained through electrolytes without the occurrence of electrode reactions. Further, it is noted if two such electrodes are used within an electrochemical cell, one being positively charged and the other negatively charged, based on Equation 4, the equivalent capacitance of the two EDLC electrodes each with a capacitance of 300 Farads will be 150 Farads. Therefore, when considering both electrodes, the sum of potential differences between both electrodes and the ions absorbed to each of them should be considered.

In the above example, once the capacitance of the 300 Farad EDLC electrode is reached, that is, after 204 (two hundred and four) seconds under a current of 2 amps, electrode reactions will start. The amount of chlorine gas produced would then follow Faraday's law of electrolysis: The mass of the substance deposited or liberated at any electrode is directly proportional to the quantity of electricity or charge passed, which is one mole of products per 96,485.3 coulombs. This means that the amount of chlorine produced could be controlled by the amount of charge passed through the electrode after its capacitance is filled to 1.36 volts.

As is well-known in the art of super capacitors, Electric Double Layer Capacitors (EDLC) are also known by such names as super capacitors or ultra capacitors, and use two oppositely charged high-capacitance electrodes. When used as electrodes in electrochemical processes, as described in U.S. Pat. No. 8,715,477, U.S. Pat. No. 9,309,133, and U.S. Pat. No. 9,315,398, each entitled “Apparatus and process for separation and selective recomposition of ions” by the present inventor, the individual ion absorption capacitance of each electrode is utilized when used in conjunction with other EDLC electrodes or electrodes that undergo redox reactions.

To qualify as a “high-capacitance” electrode as referred to herein, such as an EDLC electrode, the specific capacitance (defined as capacitance per unit mass of the electrode) is understood to be at least 1.0 Farad per gram, preferably higher than 5.0 Farads per gram, and ideally higher than 50 Farads per gram. Depending on the surface area, material of construction and the electrolytes used, especially the electrolyte concentration and ion types, specific capacitances of about 400 Farads per gram have been reported in the literature for such ultra capacitors. In practical and industrial applications of this invention, EDLC electrodes can typically have a height of 100 cm, a width of 200 cm, and a thickness of 2 cm, resulting in a mass of 24 kg to 30 kg and a capacitances of several hundred thousand Farads.

The present invention provides an improved process and apparatus for dewatering of particulate/liquid dispersions or suspensions, including oil sands tailings, using electrophoresis and electro-osmosis processes wherein the chemical composition and pH of the densified material and the extracted water are controlled and could be even unchanged. This invention also teaches specific electrode arrangements for such suspensions, and specific filtering and draining materials and fabrics for use as electrode covers that provide for improved means for the removal of densified material from the vicinity of the electrodes.

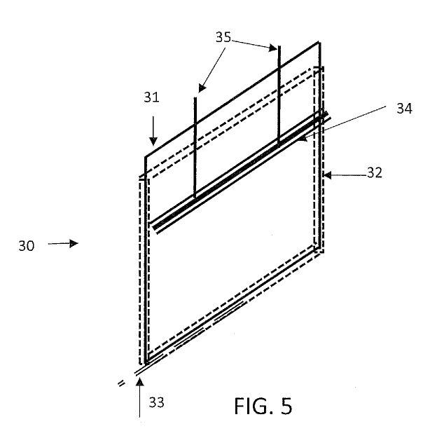

FIG. 5 illustrates a preferred embodiment of an electrode assembly 30 for a capacitive electrokinetic dewatering apparatus, according to the present invention. As shown, a planar sheet electrode 31 is in the form of a high capacitance electric double layer capacitor (EDLC) electrode sheet and is covered by an electrode cover fabric 32. The cover 32 is typically stretched over the electrode 31 in a coextensive manner, creating intimate contact with the electrode and facilitating electrical contact between the EDLC electrode and the surrounding suspension. The electrode cover 32 also allows for effective filtration and drainage of any water entering it to a drain pipe 33. The drain pipe 33 is typically fluidly connected to the electrode cover 32 at the bottom of the electrode and inside the cover and passes through an opening (not shown) in the electrode cover which is in fluid communication with the drain pipe 33. The drain pipe 33 can drain the fluid entering the electrode cover and then pass the fluid through a side wall of the dewatering cell, where the fluid can then be delivered to an outlet drain pipe for further conveyance and containment of the recovered fluid.

FIG. 5 also illustrates a plastic blade 34 extending across the electrode assembly. This blade is supported by two rods 35 that are used to move it up and down to scrape the densified material off the surface of the electrode cover 32. The mechanical system attached to the rods 35 is not shown, but the rods are powered by a mechanical system which causes the blade to move along the surface of the electrode cover 32 when scraping downward, but when moving back up the blade 34 is positioned away from the electrode cover so as to not make contact with it. Although the blade 34 and rods 35 are shown in FIG. 5 only on one side of the electrode, it is to be understood that there are two of them, one on each side of the electrode assembly.

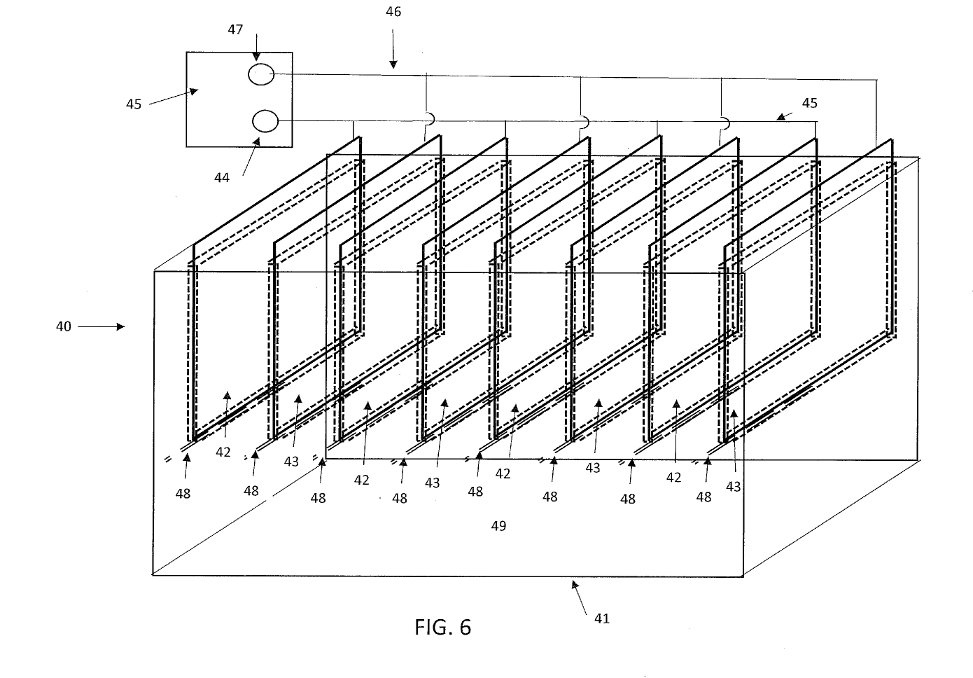

FIG. 6 illustrates a capacitive electrokinetic dewatering apparatus 40 according to the invention, which includes an insulated container 41 in the shape of a rectangular box. The container 41 has an open top and is equipped with electrode assemblies 42 and 43, each of which are essentially identical to the electrode assembly 30 in FIG. 5. In FIG. 6, connecting cables 45 electrically connect electrode assemblies 42 to one pole 44 of a reversible direct current (DC) power supply 45, and connecting cables 46 electrically connect electrode assemblies 43 to the other pole 47 of the reversible DC power supply 45. Electrode assemblies 42 and 43 have a depth less than the depth of the insulated container 41. In FIG. 6, pipe drains 48 pass through the side wall of the container 41 and can be connected to a collection drain pipe (not shown) for further conveyance and containment of the recovered fluid. The dewatering cell's insulated container 41 is filled to the top via supply lines (not shown) with a suspension to be treated 49. The scraping blades 34 and support rods 35 of FIG. 5 are not shown in FIG. 6 to avoid crowding the picture, but are assumed to be present. For proper operation and control of the process the power supply 45 should be fully instrumented and equipped with recordable voltmeters and ammeters.

FIG. 6 shows eight (8) electrode assemblies, four of which are labeled 42 and four of which are labeled 43; however, depending on the cell size, the desired production rate, and the specifications of the suspension, the number of electrode assemblies for a given dewatering application can range from a minimum of two (2) electrode assemblies to any larger number of assemblies. The electrode assemblies 42 and 43 can span the entire width of the cell, forming separated compartments between each electrode assembly, or they can be positioned such that gaps exist between the assemblies and the side walls of the insulated container 41. This positioning of the electrode assemblies 42 and 43 within the container 41 will determine whether the suspension 49 can be delivered into the insulated container 41 via each individual compartment, or on mass to the entire container 41 from a single delivery point, allowing the suspension to flow from one compartment to the other.

Once the suspension to be treated is delivered to the cell, the electrodes can be energized by the DC power supply 45, delivering electric current to each and every electrode assembly 42 and 43 and establishing current flow within the cell. The polarity of the electrodes in the electrode assemblies 42 and 43 are reversible, and the capacitive electrodes within each assembly can function either as anodes or as cathodes, depending on the polarity of the power source 45 they are connected to.

With establishment of the electric field between the capacitive electrodes, both electro-osmotic and electrophoretic processes will be initiated due to the electric field generated through the suspension. Water will flow towards the cathodes and the solids from within the suspension will move towards the anodes. As electro-osmotically generated water enters the cathodes' electrode covers, the water is drained off by the electrode covers towards the drain pipes 48 at the bottom of each assembly and right below the electrodes, and from there the water can be conveyed to the outside of the cell. At the same time, the solid materials from the suspension move towards the anodes, and the densified materials adhere to and deposit on the anodes' electrode covers. This densified material is also subject to electro-osmotic process, and water is further removed from the solidifying material at the anodes, due to the water migrating towards the cathodes. Thus, the suspension in the vicinity of the anodes typically forms a lower water content, densified material which is deposited on the anode electrode cover. Some densification of the suspension on the cathode covers due to water movement may also occur. The densified material on the anode cover has a lower water content than the suspension materials located near the cathodes, and the electrical resistivity of this densified material is higher than the remainder of the suspension. As a result, there will be higher voltage drop gradients near the anodes as compared to the rest of the suspension mass between each pair of the electrode assemblies.

In practical use of such preferred embodiment the capacitance of the individual electrodes and that of the electrode system as well as the chemical composition of the water within the suspension will be known. The known electrode system capacitance and electric current measurements provided by the power supply instrumentation, would allow the operator to determine the total charge Q in units of coulombs moved on to the electrodes at any time t from the start of a charging cycle (Q=I*t), where I is the measured current in amps and t is time in seconds. Then based on Equation 2 the voltage mobilized between the electrodes and the adjacent suspension could be calculated. Comparison of these calculated voltages with the standard electrode potential of ion species present in the suspension water then determines the allowable mobilized potential on the EDLC electrodes based on the standard electrode potentials.

As an example, with a view to FIG. 6, if the dewatering cell 41 is assumed to have internal dimensions of about 4 meters length and 2 meters width and a height of about 2 meters, we could have four sets of 1 meter deep and 2 meters wide and 3 cm thick electrodes in it. The spacing for these electrodes would then be about 50 centimeters and will result in seven compartments between the electrodes. Each of these electrodes would have a dry mass of about 45 Kilograms and based on a specific capacitance of 10 farads per gram will have capacitance of 450,000 Farads. This translates to a total capacitance of 1,575,000 Farads for the entire electrode systems. If we limit the mobilized voltage for this capacitor system to 1.2 volts which is slightly less than the required potential difference for splitting water to produce hydrogen and oxygen gasses (1.23 volts), the total charge allowed on the electrodes will be 1,890,000 coulombs. With an applied voltage of about 160 volts and a current of 80 amps between the electrodes the required time for the capacitance of these electrodes to fill to 1.2 volts for the first time will be 3375 seconds which is 56.25 minutes. For steady state charging and discharging cycles this time will be almost doubled. During this time the densified material may need to be scraped off several times before the polarity of voltage applied to the two sets of electrodes is reversed. Determination of the occurrence of redox reactions at the electrodes can be aided by a voltage measurement system which can detect resistance buildup within different areas of the suspension within the insulated container, which can also indicate if sufficient densification has occurred. Alternatively pH probes could be installed on drain lines to help detect the occurrence of redox reaction signified by a rise in pH of the extracted water. This information can then be used by the operators as a means of determining the proper time to reverse the polarity of the power source, and/or to activate the scraping mechanism of each electrode assembly.

Once the polarity is reversed, the EDLC electrodes that were previously acting as cathodes become anodes, and vice versa. Thus, upon reversal of polarity, water will now reverse its direction within the suspension and move towards the new cathodes, and the colloidal solid materials within the suspension will move towards the new anodes, where densified materials will now deposit on their electrode covers.

As an example, with a view to FIG. 6, if the dewatering cell 41 is assumed to have internal dimensions of about 4 meters length and 2 meters width and a height of about 2 meters, we could have four sets of EDLC electrodes each with a height of one meter, a width of 2 meters, and a thickness of 2 cm, and if the EDLC electrodes are made of an aerogel composite material with a dry density of about 0.75 grams per cubic centimeter and a specific capacitance of about 10 Farads per gram, then each will have a capacitance of 300,000 Farads. With these parameters, and assuming that the dominant salt in the suspension water is common salt (NaCl) and in order to avoid redox reactions at such electrodes, the voltage developed between the capacitive cathode electrodes and the ions absorbed to them should be less than standard electrode potential of 0.829 volts, which is the voltage for the water splitting electrode reaction based on Equation 1. For this electrode functioning as a cathode and receiving current of 75 amps from each side (total 150 amps), it would take approximately 1658 seconds, that is, more than 27 minutes before sufficient charge of 248,700 coulombs (300,000 farads*0.829 volts=248,700 coulombs, see Equation 2) accumulates on each high capacitance EDLC cathode electrode plate to cause redox reactions to begin to occur. Experimental observations show that this is more than enough time to reduce the water content of typical MFT to equivalent solids contents of more than 70%. At this stage the same amount of charge will be stored on the anode counter electrodes. Determination of the occurrence of redox reactions at the electrodes can be aided by a voltage measurement system which can detect resistance buildup within different areas of the suspension within the insulated container, which can also indicate if sufficient densification has occurred. Alternatively, pH probes could be installed on drain lines to help detect the occurrence of redox reaction signified by a rise in pH of the extracted water. This information can then be used by the operators as a means of determining the proper time to reverse the polarity of the power source, and/or to activate the scraping mechanism of each electrode assembly.

If at this stage the polarity of the potentials applied to the electrodes is reversed, there would be approximately 248,700 coulombs of charge stored on each electrode. This amount of charge would have to be discharge and then the equivalent amount will have to be recharged before the voltage buildup in the electrodes that were previously functioning as anodes and then were transformed to cathodes by polarity reversal to begin causing electrode reactions according to Equation 1 above (water splitting). This will almost double the time duration for each of the electrodes to function without electrode reaction and will constitute the steady state mode of operation for this dewatering cell.

If however the polarity is not reversed, the electrodes functioning as cathodes will now have their potential with respect to the ions adjacent to them exceed the standard electrode potential and water splitting would occur. This will result in introduction of hydroxide ions at the cathode electrodes that would change the pH of water entering to their location through the electrode cover. These newly generated hydroxide ions will also begin to move towards the anodes through the suspension. At this stage the potential difference between the cathode electrode and the ions and water adjacent to it will include an over potential and will be somewhat higher than the standard electrode potential of water splitting reaction of Equation 1. At the counter anodes however, the potential buildup will continue. If this process is allowed to continue by about 1062 seconds more there will be an additional 159,300 coulombs (1062 seconds*150 amps=159,300 coulombs) of charge moved on to each anode. Combined with 248,700 coulombs previously charged to these electrodes, the total charge on these high capacitance EDLC electrodes will be (248,700+159,300) 408,000 coulombs. This will raise the potential of these anode electrodes with respect to chlorine ions assumed to be present in the water adjacent to them to 1.36 volts (408,000 coulombs/300,000 Farad) which is the standard electrode potential for oxidation of chlorine ions, resulting in production of chlorine gas. Continued operation of the system will then result in production of chlorine gas.

Based on the above, with reversing the potentials applied redox reactions could be totally avoided. Alternatively, they could be also allowed, to the extend desired by allowing certain degree of their occurrence based on the degree of change desired in the chemical composition and pH of the densified material and the extracted water before the polarity of the potentials applied between the two sets of electrodes are reversed.

Test Results—

The test setup used is similar to that shown on FIG. 6, wherein the container 41 was a plastic container with a width of 10.8 cm, a length of 20 cm and a depth of 20 cm. Four (4) high capacitance EDLC electrodes, each with a planar dimension of about 6 cm by 6 cm and a thickness of about 1.1 to 1.2 cm were used. Each electrode was also covered by a 0.5 mm thick non-woven clothing insulation liner marketed under Pellon® brand as electrode cover fabric. This fabric was cut to such a size that allowed the complete covering of the electrodes with edges of the fabric glued together to create full encapsulation of the electrodes. These formed electrode assemblies 42 and 43 of FIG. 6 for this test.

Each EDLC electrode was also equipped with a nut and bolt assembly connecting the electrode to a wire. The bolted connections and the exposed wire connected to each of them were covered by a water-resistant glue (Marine glue by GOOP) to prevent interaction of these metallic wires with the suspension. The drain conduits 48 were clear flexible plastic tubes with an outside diameter of about 5 mm, and with an inside diameter of about 3 mm. Being made of clear plastic, these drainage tubes allowed direct observation of water flow in them. Each drain conduit penetrated the electrode cover by about 3 cm and was positioned below the electrode body and right next to it. This allowed any water passing through the electrode cover to be easily drained. The points of entry of each drain conduit through the electrode cover fabrics were also sealed with the same water-resistant glue.

The four electrode assemblies were placed along the 10.8 cm width of the plastic container, such that one electrode was practically positioned right next to each side wall and the other two were positioned at equal distances between them. This resulted in electrode spacings of about 1.6 to 1.8 cm. The drain conduits extended to the outside of the plastic container and exited it through the side wall at mid-height of the container on the 10.8 cm by 20 cm deep side. The drain tubes had a length of about 25 centimeters beyond the edge of the container. This allowed the tips of these tubes to be raised to allow the drained water to rise in them or could be lowered to drain the water entering them off. To make sure that the spacing between the electrodes were maintained, each of the four drain lines were passed through a 5 mm in diameter hole drilled on a 1.5 mm thick plastic strip positioned very close to the electrodes. The same was done for the wires. This way the separations between the electrodes were maintained.

In this test the connection wires from every other electrode were joined together. These wires were then connected to opposite poles of Gamry Reference 3000 potentiostat, as the power supply similar to what is shown on FIG. 6. When the pole for the reference electrode in a potentiostat is connected to one of the active or the counter electrode poles, as for this test, it functions as a DC power supply. Gamry Reference 3000 potentiostat is a high precision device capable of applying constant voltages while measuring the generated current and applying constant currents while measuring the generated voltages. The current and the voltages are displayed on a computer screen and are also numerically and graphically saved. The tests conducted were constant current tests. As such, the capacitance and voltage buildup were analyzed using the following basic relationship for charging capacitors:

V=Q/C+RI (Equation 5)

Based on the above and at time zero, that is at the beginning of the test, with stored charge “Q” on the capacitor being zero, the voltage observed, denoted as “V,” is the product of the current “I”, that for constant current test is a constant, and the total electric resistance of the circuit “R”, that is Vᵢ=RI. Assuming this product is constant (as a good approximation), any voltage buildup can be viewed as resulting from charging of the capacitor, with the capacitance “C” of the EDLC electrode being charged to total charge “Q” equal to the product of the current “I” and the time “t” from the start of charging, i.e. Q=I*t.

The capacitance of the electrodes system of the two pairs of electrodes used in this test were initially measured when the cell was filled with water from the top of a tailing pond. Allowing the voltage to build up to 1.2 volts above Vᵢ, the resulting capacitance was in the order of 96 Farads. Using this capacitance and allowing for the difference between the applied voltage V and initial voltage Vᵢ to be limited to 1.0 volts (less than electrolysis voltage of water 1.23 volts), it was determined that for a current of 0.8 amps, the time allowed should be about 120 seconds.

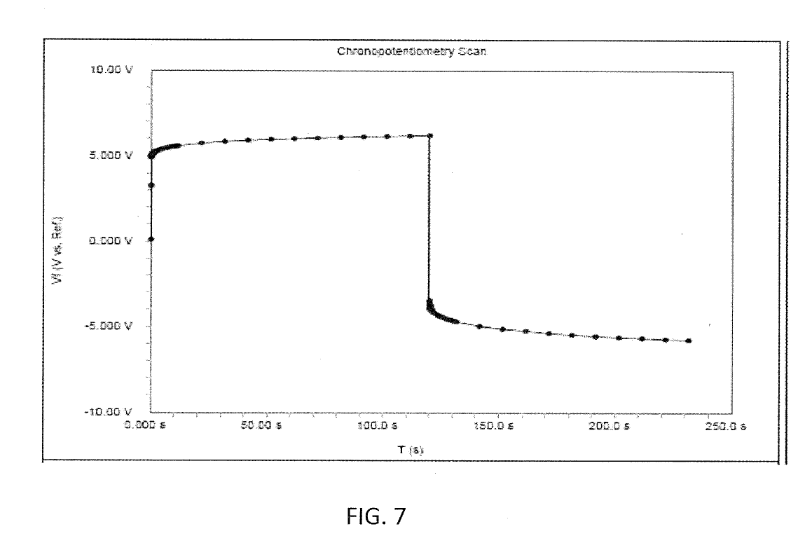

The cell was then filled with MFT from a Suncor tailings pond and the setting for the potentiostat was selected such as it would apply repeated cycles of +0.8 amps and −0.8 amps for 120 seconds. This insured that the actual potentials mobilized at the electrodes would never be above 1.0 volt even when higher voltages automatically applied by the potentiostat increased to maintain the specified constant current. The graphical output for the first cycle when operating the MFT filled cell is presented on FIG. 7. It shows Vᵢ to be 4.92 volts. The applied voltage to maintain a current of 0.8 amps then increased to 6.2 volts and then dropped to −3.5 volts when the polarity reversed. In the remaining 120 seconds this voltage further dropped to −5.8 volts. These variations in the applied voltage to maintain the applied constant currents are then the response of the circuit as the capacitive electrodes are charged and the material densifies.

When filling the cell with MFT it was made sure that all four electrodes were fully submerged. At the same time a moisture content sample was taken from the MFT that upon drying in a 105 degree Celsius oven by the next day showed that it had a moisture content of 146.6%, corresponding to a solids content of 40.5%. The setup was then allowed to sit idle for about an hour to allow for full saturation of the electrodes and electrode covers. During this time it was observed that a small amount of rather turbid water filled the drain lines. The pH of this water was measured by a pH paper (Fisher scientific, Fisher brand pH paper 0.0 to 14.0). It indicated a pH of about 9.

The test was then started by powering up the potentiostat while the drain lines were lowered to allow the outward flow of any water entering them. The drain lines from each pair of the electrodes connected to the same pole of the potentiostat were directed to a separate container for collection. The test was carried out by application of 15 cycles of +0.8 amps and (negative) −0.8 amps, each for 120 seconds. It was observed that within about 20 seconds from the start of each charging cycle, water would flow out of the drain lines connected to the pair of electrodes functioning as the cathodes, with more water coming out of the middle electrode that was positioned between two anodes than the side electrode which was adjacent to one anode. This matched the expectation as the current to and from the middle electrodes are double of the same for the side electrodes.

With advancement of the test it was also observed that the flow out of the drain lines connected to the cathode electrodes would stop and even reverse when these electrodes switched roles, upon polarity reversal and became anodes. The pH of water coming out was systematically assessed using the same pH paper as before throughout the test at maximum 2 minutes intervals. All measurements throughout the test indicated the same reading of pH=9. At the end of the first 15 cycles of charging and discharging each pair of electrodes 42 milliliters of water had exited the cell. At this point the pH of this sample was measured by a “pHTestr 10” waterproof pH meter after its full calibration. The result was a pH of 9.1. The electrical conductivity of this extracted water was measured by a “PINPOINT” “Salinity Monitor” conductivity meter which registered a conductivity of 7.3 mS/cm. The sequence of 15 cycles of charging and discharging was continued for two more times with the same pattern of observations, with pH of extracted water remaining in the 9 range as evaluated by pH paper and between 9.1 and 9.2 when measured by the pH meter.

After the first and the third sequence of 15 cycles of charging and discharging, the electrodes were raised and samples of the densified material on the surface of the electrode covers were extracted for moisture content measurements. The results were the first and the third sequences were 75.0% and 82.4% corresponding to solids contents of 57% and 54% respectively. The total volume of water collected at the end of the test was measured to be 76 milliliters.

At the end of this phase of the experiment the voltage applied by the potentiostat was raised to constant value of 10 volts at which time the current increased to about 1.94 amps and then began to decrease. Within about one minute after the start of this phase of the test, the pH of the water exiting the cathode drain line increased to 12 range as measured by pH paper. Measurement the pH for the sample collected yielded a pH of 11.8. This clearly shows that once the capacitance of the electrodes reached the point of initiating redox reactions, such reactions were initiated as verified by the observed pH increase of the water coming out of the cathodes.

The observation that water did flow to and then out of the cathode electrodes used and that the solids from the suspension collected and densified on the surfaces of the electrode covers clearly confirm that electro-osmosis and electrophoresis processes could be caused by capacitively generated electric fields. They further confirm that by the use of high capacitance EDLC electrodes, redox reactions at electrodes could be avoided in capacitive electrokinetic dewatering of suspensions, resulting in maintaining the PH and chemical composition of the extracted water and the densified material constant. They further demonstrate that once the capacitance of such EDLC electrodes are filled, resulting in the development of higher than standard electrode potential differences between the electrode body and the ions absorbed to them, redox reactions are initiated, changing the pH and chemical composition of the water and the densified material.

The present invention provides a capacitive dewatering apparatus capable of reduced spacing between the capacitive electrodes, which can reduce the voltage level required to achieve a sufficient level of electric field intensity while increasing the rate of densification and dewatering. It also provides a capacitive dewatering process and apparatus in which the composition and pH of the densified material and the extracted water can be controlled or maintained constant/unchanged. Likewise, it provides a capacitive electrokinetic process that minimizes the amount of redox reactions occurring at the electrodes while providing reliable electric contact between the capacitive electrodes and the colloidal suspension and allowing for simultaneous drainage of recovered fluid from the location of the capacitive electrodes. The inventive dewatering process and apparatus disclosed herein increases the exposed surface area of each electrode, in comparison to the volume of the suspension being treated, in comparison to prior art in situ operations, and thus can provide a plant-based capacitive dewatering operation which can produce a high-volume, low-cost treatment for large colloidal suspensions in general, and oil sands tailings in particular.

While the present invention has been illustrated by the description of embodiments and examples thereof, it is not intended to restrict or in any way limit the scope of the appended claims to such detail. Additional advantages and modifications will be readily apparent to those skilled in the art. Accordingly, departures may be made from such details without departing from the scope of the invention.

What is claimed is:

1. A capacitive electrokinetic process for densifying solids and recovering water from colloidal suspensions without changes in chemical composition and pH of the densified material and the extracted water, the process comprising the steps of:
a) providing an insulated container, the insulated container including at least one outlet drain line for removing water therefrom;
b) providing an electric current power supply for generating an electric field through the suspension, wherein the power supply includes a positive pole and a negative pole and is capable of polarity reversal;
c) providing at least one pair of high capacitance electric double-layer capacitor (EDLC) electrodes connected to opposite poles of the power supply, wherein each electrode of the at least one pair of EDLC electrodes has a specific capacitance of at least 1.0 farad per gram and is spaced apart from the other electrode within the insulated container;
d) providing each EDLC electrode with an electrode cover for placement over the EDLC electrode, wherein each electrode cover is made of a fabric which allows the passage of ions, water and electricity therethrough and facilitates electrical contact between the EDLC electrode and the surrounding suspension;
e) providing each electrode cover with a drain conduit, wherein each drain conduit is positioned below its corresponding EDLC electrode and is hydraulically connected to its corresponding electrode cover and to the at least one outlet drain line;
f) providing a suspension to be treated in the insulated container;
g) applying a potential difference between the EDLC electrodes via the power supply to generate an electric field through the suspension, wherein electric current flow through the suspension is established and maintained by the EDLC electrodes without the occurrence of redox reactions at their surfaces so long as the potential difference between the EDLC electrodes and the ions in the surrounding suspension ions is below the standard electrode potential of the ions in the surrounding suspension;
h) detecting the initiation of redox reactions at the EDLC electrode surfaces;
i) upon the detection of redox reactions at the EDLC electrode surfaces, reversing the electric field direction through the suspension by reversing the polarity of the potential difference applied between the EDLC electrodes via the power supply;
j) removing water from the insulated container through the at least one outlet drain to achieve water extraction from the suspension and densification of solids within the suspension;
k) removing the treated suspension from the insulated container; and
l) repeating steps (g) through (k).

2. The process of claim 1, wherein the step of (h) detecting the initiation of redox reactions at the EDLC electrode surfaces is performed by detecting pH changes in the water recovered at the at least one outlet drain line.

3. The process of claim 1, wherein the step of (h) detecting the initiation of redox reactions at the EDLC electrode surfaces is performed by detecting voltage changes between the EDLC electrode surfaces and the suspension.

4. The process of claim 3, wherein detecting voltage changes between electrodes and various points in the suspension is used as a guide to affect removal of the densified material from the dewatering cell.

5. The process of claim 1, wherein the specific capacitance of the high capacitance EDLC electrodes is more than 1 farad per gram and less than 5 farads per gram.

6. The process of claim 1, wherein the specific capacitance of the high capacitance EDLC electrodes is more than 5 farads per gram and less than 50 farads per gram.

7. The process of claim 1, wherein the specific capacitance of the high capacitance EDLC electrodes is more than 50 farads per gram and less than 400 farads per gram.

8. The process of claim 1, wherein the specific capacitance of the high capacitance EDLC electrodes is more than 400 farads per gram.

9. The process of claim 1, wherein the suspension to be treated is a colloidal suspension containing charged particles and electro-active materials.

10. The process of claim 1, wherein the suspension to be treated is selected from the group consisting of oil sands tailings, clay-water suspensions such as Mature Fine Tailings (MFT), dispersions or suspensions of inorganic particles that are a by-product of mining, manufacturing or other industrial processes, food and food processing waste suspensions, biological wastes, and biomass sludges.

11. An apparatus for capacitive electrophoretic densification of solids and capacitive electro-osmotic removal of fluids from a colloidal suspension, the apparatus comprising:
a) an insulated container for receiving and containing a suspension to be treated, the insulated container including at least one outlet drain line for removing water therefrom;
b) an electric current power supply for generating an electric field through the suspension, wherein the power supply includes a positive pole and a negative pole and is capable of polarity reversal;
c) at least one pair of high capacitance electric double-layer capacitor (EDLC) electrodes connected to opposite poles of the power supply, wherein each electrode of the at least one pair of EDLC electrodes has a specific capacitance of at least 1.0 farad per gram and is spaced apart from the other electrode within the insulated container;
d) at least one pair of electrode covers placed over the at least one pair of EDLC electrodes, wherein each electrode cover is made of a fabric which allows the passage of ions, water and electricity therethrough and facilitates electrical contact between the EDLC electrode and the surrounding suspension; and
e) at least one pair of drain conduits positioned below the at least one pair of EDLC electrodes, wherein each drain conduit is hydraulically connected one of the at least one pair of electrode covers and to the at least one outlet drain line;

12. The apparatus of claim 11, wherein the suspension to be treated is a colloidal suspension containing charged particles and electro-active materials.

13. The apparatus of claim 11, wherein the suspension to be treated is selected from the group consisting of oil sands tailings, clay-water suspensions such as Mature Fine Tailings (MFT), dispersions or suspensions of inorganic particles that are a by-product of mining, manufacturing or other industrial processes, food and food processing waste suspensions, biological wastes, and biomass sludges.

14. The apparatus of claim 11, wherein the specific capacitance of the high capacitance EDLC electrodes is more than 1 farad per gram and less than 5 farads per gram.

15. The apparatus of claim 11, wherein the specific capacitance of the high capacitance EDLC electrodes is more than 5 farads per gram and less than 50 farads per gram.

16. The apparatus of claim 11, wherein the specific capacitance of the high capacitance EDLC electrodes is more than 50 farads per gram and less than 400 farads per gram.

17. The apparatus of claim 11, wherein the specific capacitance of the high capacitance EDLC electrodes is more than 400 farads per gram.
